(19) United States
(12) Patent Application Publication
(10) Pub. No.: US 2022/0004003 A1
(43) Pub. Date: Jan. 6, 2022

(54) Illumination Waveguide

(71) Applicant: Avegant Corp., San Mateo, CA (US)

(72) Inventors: Aaron Matthew Eash, San Francisco, CA (US); Andrew John Gross, Chassell, MI (US); Christopher David Westra, San Carlos, CA (US); Edward Chia Ning Tang, Menlo Park, CA (US); Warren Cornelius Welch, III, Foster City, CA (US); Joseph Daniel Lowney, Tucson, AZ (US)

(73) Assignee: Avegant Corp., San Mateo, CA (US)

(21) Appl. No.: 17/365,982

(22) Filed: Jul. 1, 2021

Related U.S. Application Data
(60) Provisional application No. 62/705,543, filed on Jul. 2, 2020.

(51) Int. Cl. G02B 27/01; F21V 8/00; G02B 5/32; G02B 5/26

(52) U.S. Cl. CPC G02B 27/0172; G02B 6/0035; G02B 6/0023; G02B 5/26; G02B 6/0073; G02B 5/32

(57) ABSTRACT

An illumination waveguide is described having a top surface and a bottom surface, and a plurality of reflective elements within the waveguide, the reflective elements at an angle to the top surface of the waveguide, the reflective elements providing one or more of: an in-coupler, an out-coupler, and an extender to the waveguide. The illumination waveguide is configured such that light from the waveguide is directed to a spatial light modulator, and the modulated light is directed through the waveguide to a user.

### RELATED APPLICATION

The present application claims priority to U.S. Provisional Application No. 62/705,543, filed on Jul. 2, 2020, and incorporates that application in its entirety.

### FIELD OF THE INVENTION

The present application relates to waveguides and in particular an illumination waveguide directing light to a spatial light modulator.

### BACKGROUND

For many displays, the system includes a set of optics, through which light is directed to a spatial light modulator, which is typically a digital micromirror device (DMD) or Liquid Crystal on Silicon (LCOS) chip. The optics generally include a prism and one or more lenses to focus the light. The DMD reflects the light through another set of optics. The second set of optics, directing the light from the DMD to the user's eye, may include one or more lenses, and optionally a waveguide.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 illustrates one embodiment of an illumination waveguide having a diffractive in-coupler and a diffractive out-coupler.

FIGS. 2A-2E illustrate embodiments of a waveguide including a reflective element out-coupler, using fleck mirrors.

FIGS. 3A-31 illustrate various embodiments of mirror shapes that may be used as part of the reflective element for the waveguide.

FIG. 4 illustrates a top view of one embodiment of a set of varied mirror shapes distributed with a random pattern spacing.

FIG. 5 illustrates a top view of another embodiment of random distribution of mirrors of different shapes.

FIG. 6A-6B are diagrams of one embodiment of a reflective in-coupler using dichroic mirrors.

FIGS. 7A-7B are diagrams of one embodiment of a reflective in-coupler using fleck mirrors.

FIGS. 8A-8C are diagrams of one embodiment of a waveguide including a reflective in-coupler and a reflective out-coupler.

FIGS. 9A-9C are diagrams of one embodiment of a reflective element for expansion in a waveguide.

FIG. 10A-10C are diagrams illustrating various embodiments of altering the sloped surfaces of the waveguide.

FIGS. 11A-11B are diagrams illustrating one embodiment of a waveguide having multiple in-coupled light packages.

FIG. 12A-12B are diagrams illustrating one embodiment of using a micro-LED panel for selective lighting of a spatial light modulator.

FIG. 13 is a flowchart of one embodiment of manufacturing the reflective element using fleck mirrors.

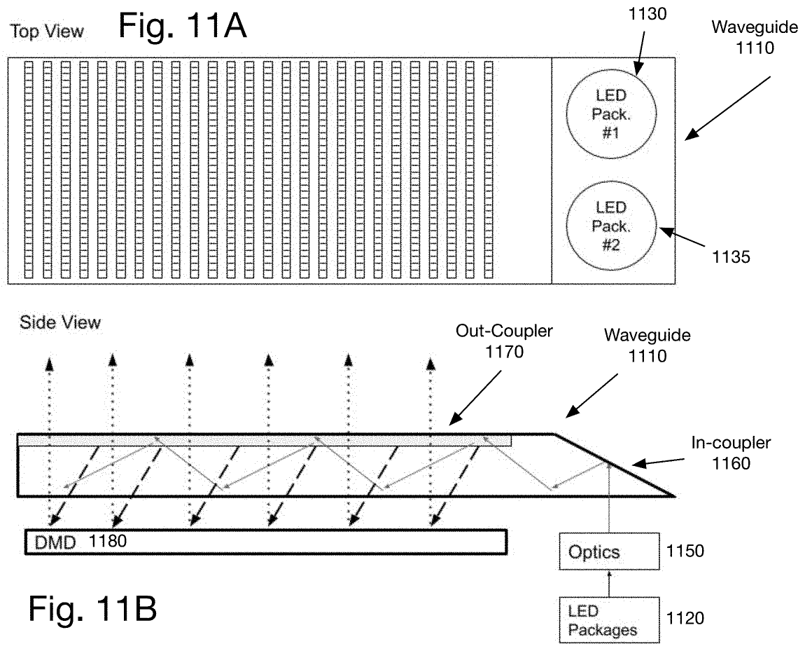

FIG. 11 is a diagram illustrating one embodiment of a waveguide having multiple in-coupled light packages.

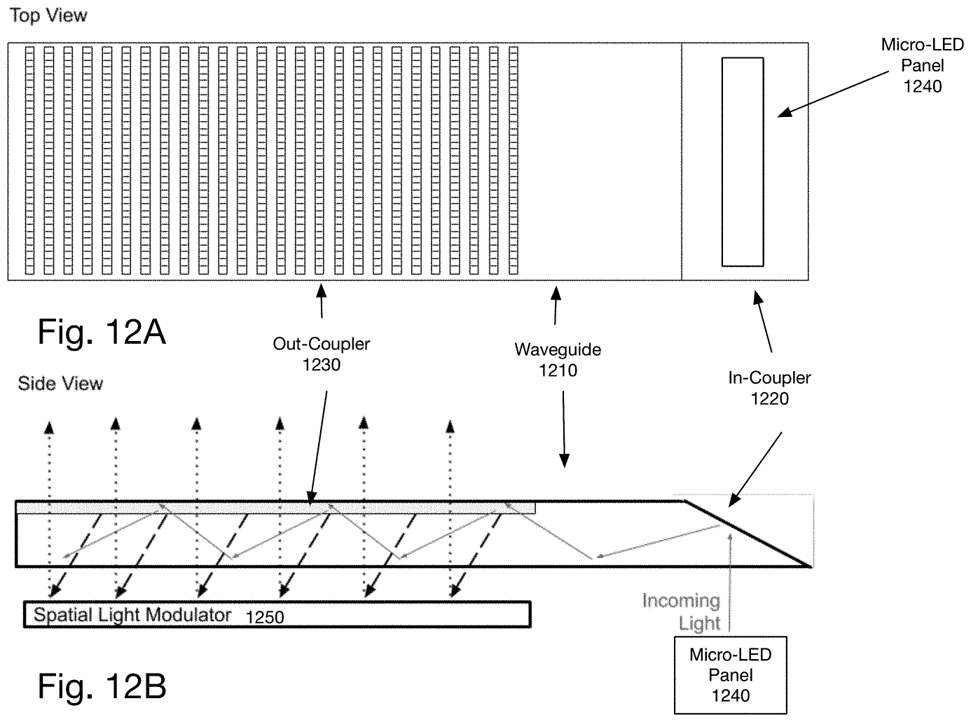

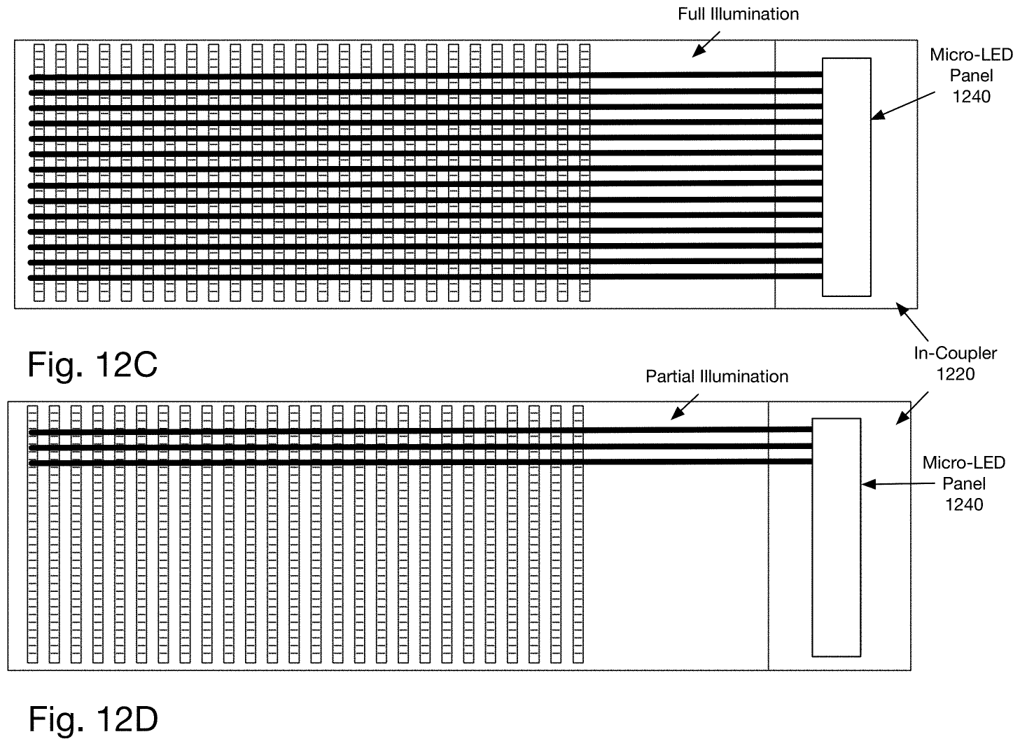

FIG. 12A-12D are diagrams illustrating one embodiment of using a micro-LED panel for selective lighting of a spatial light modulator.

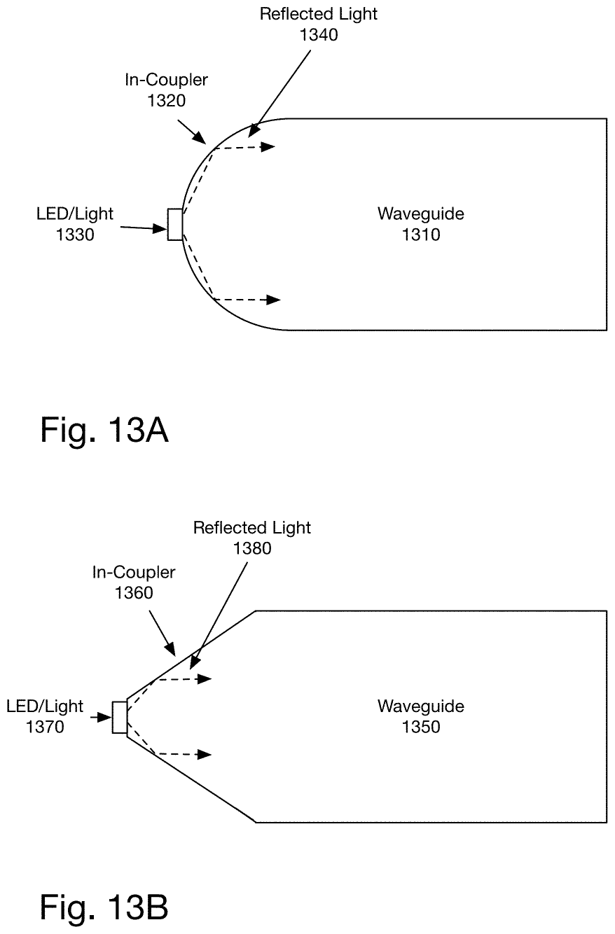

FIGS. 13A-13B illustrate embodiments of a shaped in-coupler that may be used with a waveguide.

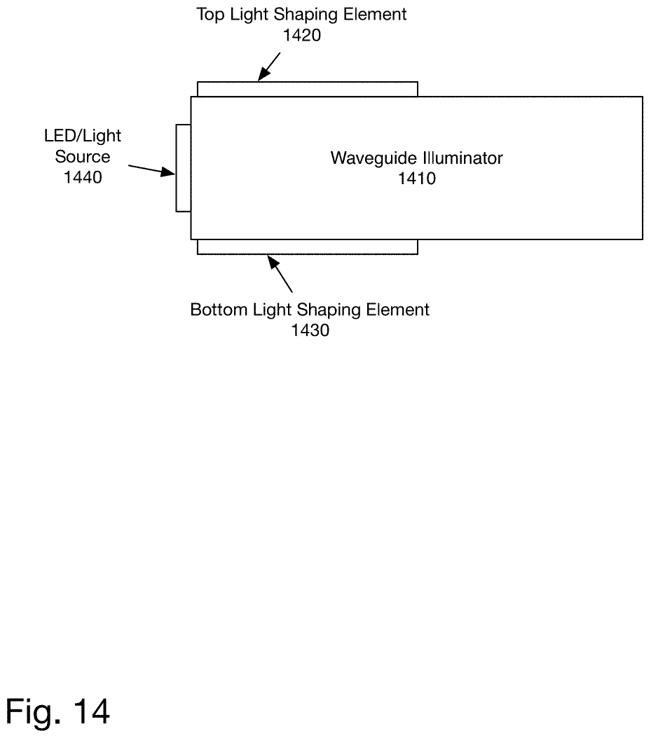

FIG. 14 illustrates one embodiment of light-shaping elements on the top and bottom surface of the waveguide illuminator.

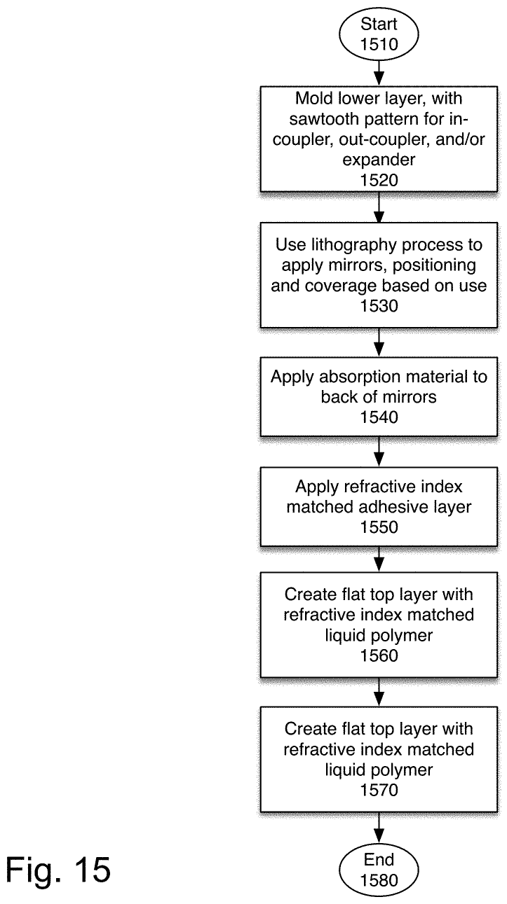

FIG. 15 is a flowchart of one embodiment of manufacturing the reflective element using fleck mirrors.

### DETAILED DESCRIPTION

An illumination waveguide for directing light to a spatial light modulator is described. In one embodiment, the waveguide includes a reflective element for in-coupling, out-coupling, or expansion of the light inside the waveguide. In one embodiment, the reflective element comprises a set of fleck mirrors embedded at an angle in the waveguide to reflect portions of the light. In one embodiment, the fleck mirrors are placed on sawtooth elements within the waveguide.

These reflective elements may be used for out-coupling light from the waveguide, in-coupling light into the waveguide, and/or as an expansion element in the waveguide. These methods offer several advantages over using diffractive elements—the mirrors reflect a broad spectrum of light, and their reflectivity is fairly constant across that spectrum, making the design easier and more efficient than a design that uses diffractive optical elements. In one embodiment, the waveguide may have multiple light packages coupled into it, either via two or more sets of LEDs or via a micro-LED panel, to adjust the uniformity of lighting of the spatial light modulator.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional, and other changes may be made without departing from the scope of the present invention. The following detailed description is, therefore, not to be taken in a limiting sense, and the scope of the present invention is defined only by the appended claims.

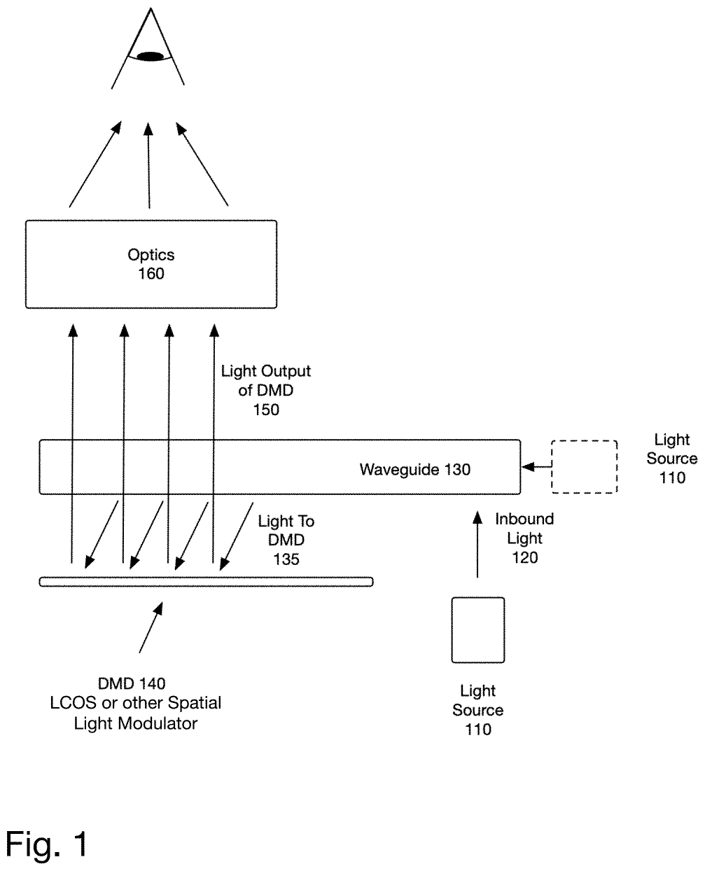

FIG. 1 illustrates an illumination waveguide for directing light to a spatial light modulator. The system includes, in one embodiment, a light source 110, projecting a light 120 into a waveguide 130. The illumination waveguide may be particularly useful in a head-mounted device (HMD) such as goggles or glasses, to present augmented reality (AR), virtual reality (VR), or mixed reality (MR) images to a user. The present illustrations do not show other elements such as optics and additional mirrors which may be part of such a system.

The light source 110 may be coherent or non-coherent. In general, “coherent light” is temporally, spatially, and spectrally coherent. In one embodiment, non-coherent light sources may include sources such as light emitting diodes (LEDs), microLEDs, superluminescent diodes (sLED), quantum dots illuminated by ultraviolet (UV) light, or non-time coherent lasers. In one embodiment, the light source 110 may be temporally coherent. In one embodiment, the light source 110 may be spatially coherent. In one embodiment, the light source 110 may propagate to the waveguide 130 through a fiber optic.

The waveguide 130, in one embodiment is a planar waveguide. In one embodiment, the waveguide 130 has a coupling element for in-coupling, and out-coupling. In one embodiment, the coupling element is a diffractive grating. In another embodiment, the coupling element may be a holographic optical element (HOE). In one embodiment, as will be shown below, the coupling element for in-coupling and/or out-coupling may be a non-diffractive element, such as a reflective element.

The waveguide 130 directs the light to a spatial light modulator 140. In one embodiment, the spatial light modulator is a digital micromirror device (DMD) 140. The light output 150 of the DMD 140 passes through the waveguide 130, in one embodiment. The light output 150 is not coupled into the waveguide 130 but rather passes through it.

The light output 150 is then optionally directed through optics 160, to the user's eye. In one embodiment, optics 160 may include a second waveguide, to redirect the light. Although the alignment of the elements shown here may be used, the light may be redirected using mirrors, additional waveguides, fiber optics, or other optical elements, without departing from the scope of the present application.

In this figure, and the figures below conventional optical elements are not shown. Additionally, while the waveguide is shown in a compact form, one of skill in the art would understand that the length of the waveguide is arbitrary, because the total-internal-reflection (TIR) transmission of light is nearly lossless through the waveguide.

This system is particularly useful in head mounted devices, where the reduced size and weight is beneficial.

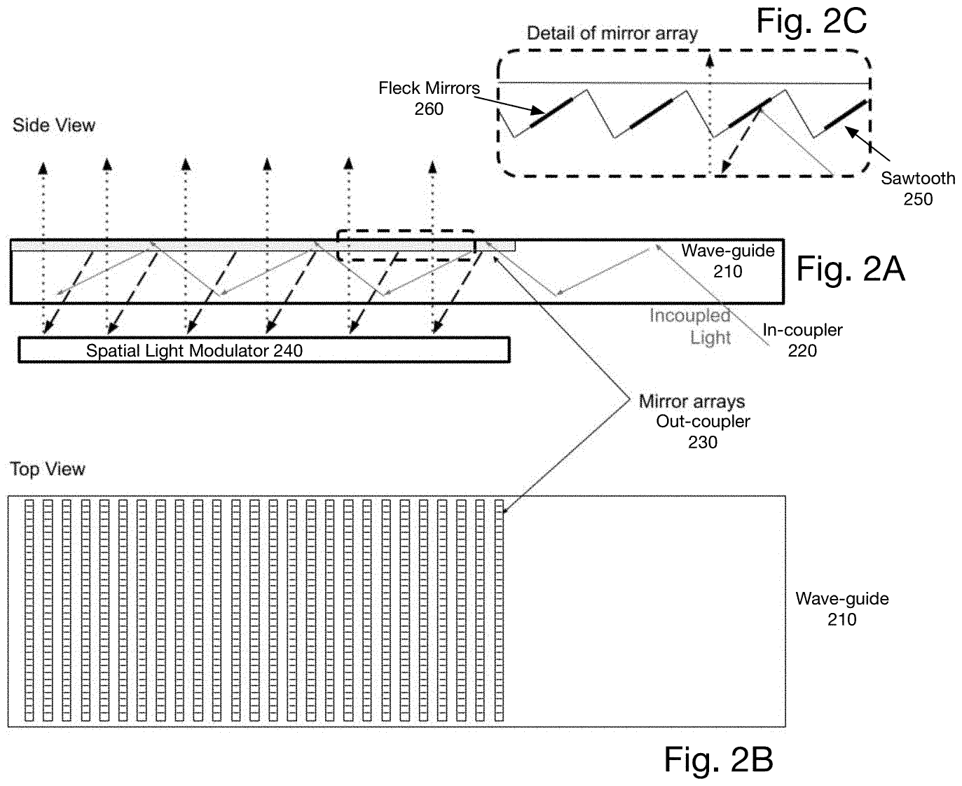

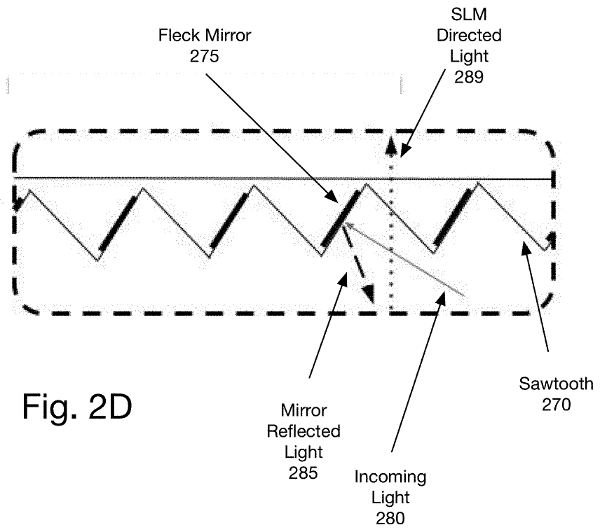

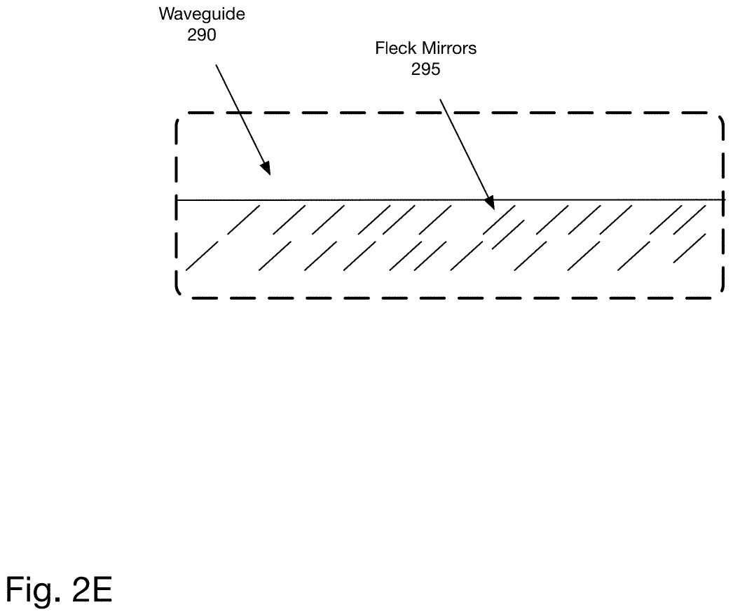

FIGS. 2A-2C illustrate one embodiment of a waveguide including a reflective element out-coupler, using fleck mirrors. The waveguide shown may be used in a system such as the one shown in FIG. 1, as an illumination waveguide.

The waveguide 210 includes an in-coupler 220 and a reflective out-coupler 230. The reflective out-coupler 230 reflects the light initially to the spatial light modulator 240. The spatial light modulator (SLM) 240 may be a digital mirror device (DMD) and liquid crystal on silicon (LCOS) system, or another SLM.

The light reflected by the SLM 240 passes through the out-coupler 230, toward the user's eye. FIG. 2B shows a top view of the waveguide 210, showing one embodiment of the array of fleck mirrors 260 across the waveguide. Although the fleck mirrors 260 appear continuous, in one embodiment, they are discrete non-overlapping mirror elements.

FIG. 2C illustrates an enlarged portion of one embodiment of the out-coupler 230. In one embodiment, the out-coupler 230 includes a pattern of sawtooth elements 250 with fleck mirrors 260 on the surface. In one embodiment, the mirrors 260 are on the portion of the sawtooth elements 250 that are angled at an acute angle to the top surface of the waveguide 210. In one embodiment, the angle of the sawtooth elements 250 is chosen to match the angle of the fleck mirrors to a digital micromirror device. In one embodiment, the sawtooth angle may be between 10 and 80 degrees. In one embodiment, the fleck mirrors do not cover the entire top surface of the waveguide, they only take up a percentage of the area, referred to as the fill factor. In one embodiment, each fleck mirror 260 is a continuous line across a portion of the sawtooth 250. In another embodiment, the fleck mirrors 260 are discrete elements that do not overlap. In one embodiment, the fleck mirrors 260 may have various shapes.

FIG. 2D illustrates an enlarged portion of another embodiment of the out-coupler 230. The out-coupler includes a pattern of sawtooth elements 270, with fleck mirrors 275 on the surface. The fleck mirrors 275 are steeply angled with respect to the top surface of the waveguide. The incoming light 280 is reflected by the fleck mirrors 275. The reflected light 285 travels at an angle to the spatial light modulator (not shown). The spatial light modulator directed light 289 passes back through the waveguide, toward the optics which will direct the light to the user's eyes. In one embodiment, the spatial light modulator is reversed in this configuration, so the incoming light is directed at an appropriate angle. In this configuration, the apparent fill factor from the perspective of the light moving down the waveguide is higher than the apparent fill factor from the perspective of the light reflected from the spatial light modulator back through the waveguide.

FIG. 2E illustrates an enlarged portion of another embodiment of the out-coupler 230. The out-coupler includes a pattern of fleck mirrors 295 at an angle within the waveguide 290. The fleck mirrors 295 in this configuration are placed without using sawtooth shapes. One alternative approach may be using flat pieces of glass with fleck mirrors on them, within the waveguide, positioned at an angle. Another alternative approach may be to deposit the angled fleck mirrors within the waveguide during manufacturing. Other methods of generating the angled fleck mirrors with the determined level of coverage may be used.

The fleck mirrors 260 in one embodiment are made of a reflective material, like aluminum or silver. In one embodiment, fleck mirrors 260 are made of a color selective material so each mirror only reflects a specific color. In such an embodiment, mirrors for each of the three colors are distributed within the waveguide. The mirrors 260, in one embodiment, can also be made of a dielectric material, such as titanium dioxide or other dielectrics with different index of refraction.

The angle between the sloped surface of the sawtooth elements 250 and the surface of the waveguide can be between 1° and 80°. The angle of each sloped surface of the sawtooth elements 250 can be the same for one waveguide or it can vary along the waveguide. The sloped surface of the sawtooth elements 250 on which the fleck mirrors 260 are placed may be flat, or curved, concave, or convex. There can be a variety of size ranges for the sawtooth, in one embodiment, a sawtooth is 50 μm tall, spaced from the next sawtooth by 100 μm, in a waveguide that is between 0.1 mm and 5 mm high. In another embodiment, the sawtooth may be as large as 1 mm tall and spaced by 2 mm to the next sawtooth. In one embodiment, the sawtooth may be less than 1% of the waveguide height. In one embodiment, each sawtooth is straight, extending from one side of the waveguide to the other. In one embodiment, the sawtooth shapes follow a curved path from one side of the waveguide to the other. In one embodiment, the sawtooth shapes do not run continuously across the width of the waveguide, they are broken up into short lengths of sawtooth shapes that cover the full width of the waveguide.

In one embodiment, the backside of the mirrors is light absorbing. In one embodiment, the light absorbency may be achieved by adding a layer of light absorbing material to the back side of the mirror to reduce unwanted reflections. In one embodiment, a layer of metal, thin film black carbon, polarizer material, porous chromium, carbon, or another visible light absorbing layer may be used. Alternatively, the material deposited for the fleck mirrors may have a light absorbing side.

In one embodiment, the sawtooth elements 250 and mirror array can be deeper within the waveguide than shown. In one embodiment, the mirror array may be anywhere within the waveguide.

In one embodiment, the angles of the sawtooth elements may vary. In another embodiment, the sawtooth may be curved along 1 or 2 axes. In one embodiment, the angle of the sloped surfaces of the sawtooth elements 250 may be varied along the length of the waveguide. In one embodiment, the density of sawtooth elements may be varied. In one embodiment, the density of sawtooth elements increases along the length of the waveguide, to increase outcoupling of the light as it travels down the waveguide.

The fleck mirrors 260 are small and discontinuous across the mirror arrays 230. In one embodiment, the fleck mirrors 260 are deposited on the sloped surface of the sawtooth elements 250 inside the waveguide, and can be any of various shapes. The fleck mirrors 260 may include, for example, different shapes such as circles, squares, long rectangles, or other polygonal shapes. In one embodiment, the fleck mirrors 260 may have a variety of shapes in a single waveguide.

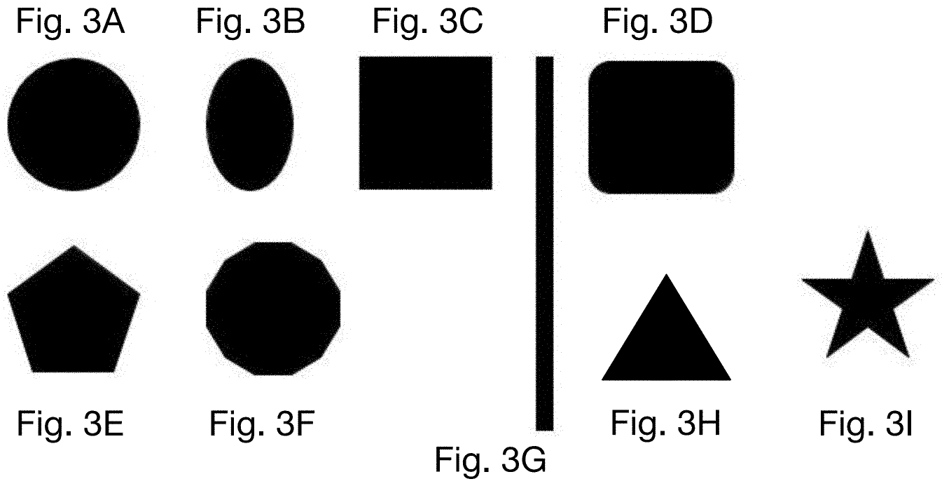

FIGS. 3A-31 illustrate some exemplary fleck mirror shapes that may be used. Mirror shapes may vary within a single waveguide. Furthermore, mirror shapes need not be contiguous but may have a broken portion or a gap. Other shapes may be used.

The mirror dimensions may range from 1 μm-1 mm, in one embodiment, such that a circle may have a diameter between 1 and 1 mm or a rectangle may have a side between those lengths. A rectangular mirror may have one side just a few microns and the other much longer. All the mirrors can be the same size, or the sizes can vary in a single waveguide.

Returning to FIGS. 2A-2C, the fleck mirrors do not cover the entire top surface of the waveguide. The fill factor can range from 5-80% depending on the reflectivity of the mirrors, which can vary from 10%-100%. In one embodiment, the fill factor may be varied based on size, cost, efficiency, and/or uniformity goals. In one embodiment, for fully reflective mirrors the fill factor may be between 5% and 20%. In one embodiment, for partially reflective mirrors, the fill factor may be between 25% and 80%. In one embodiment, the fill factor may vary along the waveguide, with a higher fill factor further from the in-coupler. In one embodiment, the fill factor at the beginning of the out-coupler is 10% and it increases to 20% across the waveguide.

The mirrors can be regularly spaced across the coupling portion of the waveguide, or they can be randomly placed. The sawtooth shapes may be in regular rows that are perpendicular to the side of the waveguide illuminator, or they can be curved or irregularly spaced.

In one embodiment, the fleck mirrors are polarization selective mirrors. In one embodiment, some of the mirrors may reflect light with one polarization and pass light with the other polarization, while others of the mirrors do the opposite. In one embodiment, when the mirror is a polarization sensitive mirror, a quarter wave plate or other element to alter polarization of the light may be added between the waveguide 210 and the SLM 240. In one embodiment, the light may be modulated at the input to choose one of two polarization states to select which mirrors to reflect off of. The differently polarized mirrors may be placed at different sawtooth angles with respect to the waveguide or as different shapes on sawtooth shapes or with different materials or reflectivities. A sawtooth element may have mirrors for both polarizations, in one embodiment.

In one embodiment, the mirrors may be color selective mirrors. If the mirror are color selective, in one embodiment, a color filter is used with the waveguide.

In one embodiment, if the mirrors are color selective, mirrors for each of the colors being guided through the waveguide may be present. A sawtooth element may have mirrors for one or more colors, in one embodiment.

In another embodiment, the mirrors may be made of a dielectric material. In one embodiment, the dielectric material is TiO2.

In one embodiment, the fleck mirrors are partial mirrors. Using a partial mirror or dielectric mirror allows for a higher fill factor (more of the area covered by mirror), while retaining transmissivity on the return pass from the spatial light modulator, because the reflectivity depends on the angle of the light. In one embodiment, for partially reflective mirrors, the reflectivity of the mirrors may be varied across the out-coupler based on efficiency and/or uniformity goals. In one embodiment, the reflectivity may be varied using a stepped coating process.

In one embodiment, the fleck mirror is made of a holographic material that reflects certain wavelengths and lets other wavelengths pass through. In one embodiment, the wavelengths reflected by each individual mirror can vary, such that if two light sources with different emission profiles are used, one subset of mirrors would reflect only the light from one light source and another subset of mirrors would reflect only light from the other light source. In one embodiment, such holographic mirrors may be placed on different sawtooth angles with respect to the waveguide or as different shapes on a sawtooth.

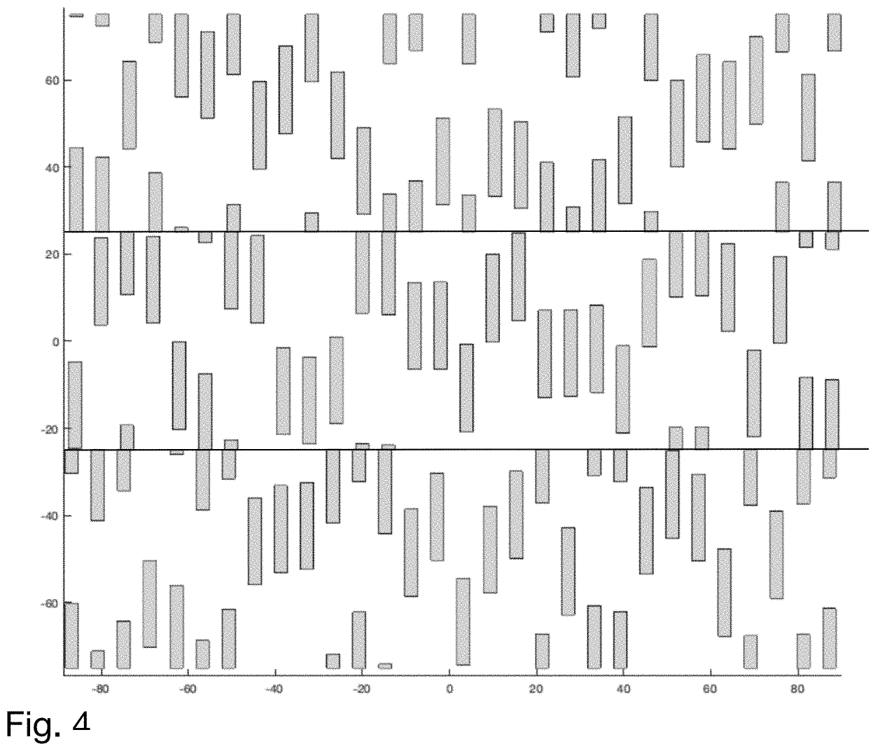

FIG. 4 illustrates a top view of one embodiment of a set of varied fleck mirror shapes distributed with a random pattern spacing across three sawtooth elements. The mirrors shown in FIG. 4 are rectangular mirrors of approximately similar width and varied lengths, and are randomly distributed. A random distribution of the mirrors reduces the risk of refractive patterns. The shapes of the mirrors may further vary as shown in FIGS. 3A-31. A single waveguide may include mirrors of a variety of shapes.

In one embodiment, the back of the mirrors—the side toward the exit surface of the waveguide—is light absorbing. This reduces unwanted reflections. In one embodiment, the light absorption comes from the material of the mirror. In another embodiment, the light absorption comes from a coating applied to the mirror, as discussed above.

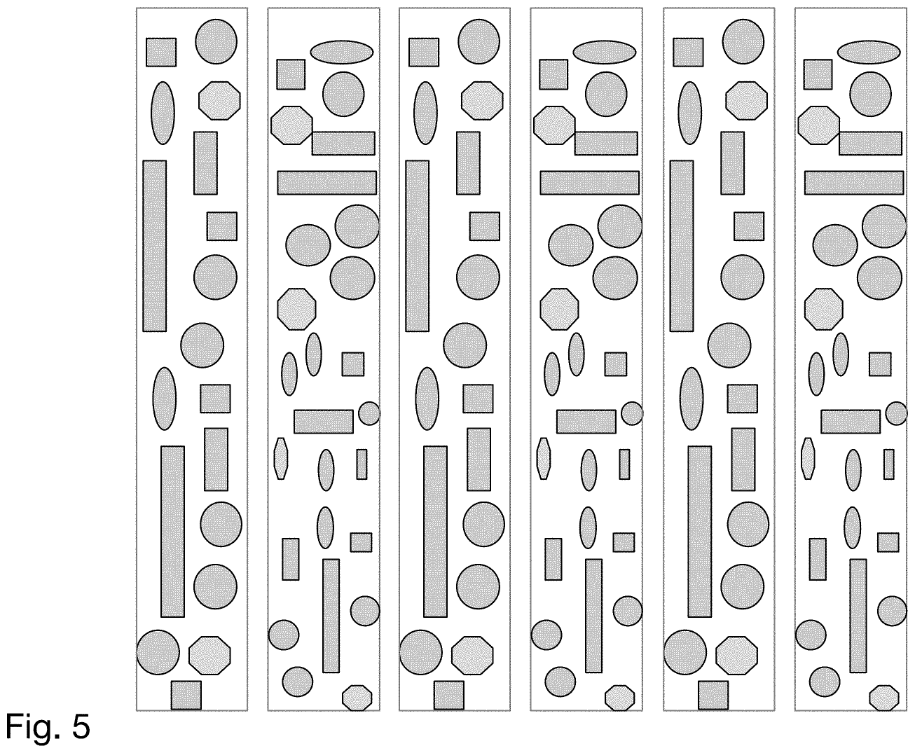

FIG. 5 illustrates a top view of another embodiment of random distribution of mirrors of different shapes. The top view shows portions of sawtooth sides, which include mirrors of various sizes. The illustration is not proportionate, as the relative size of the mirrors may be much smaller, compared to the size of a sawtooth on which mirrors are positioned. As noted above, these mirrors may be dichroic mirrors, holographic mirrors, partial mirrors, or holographic or otherwise selective for the portion of the light which they reflect. In some embodiments, the different types of mirrors may be different shapes. In one embodiment, the mirrors may be the same shape but different size—e.g., round or oval mirrors of different diameters.

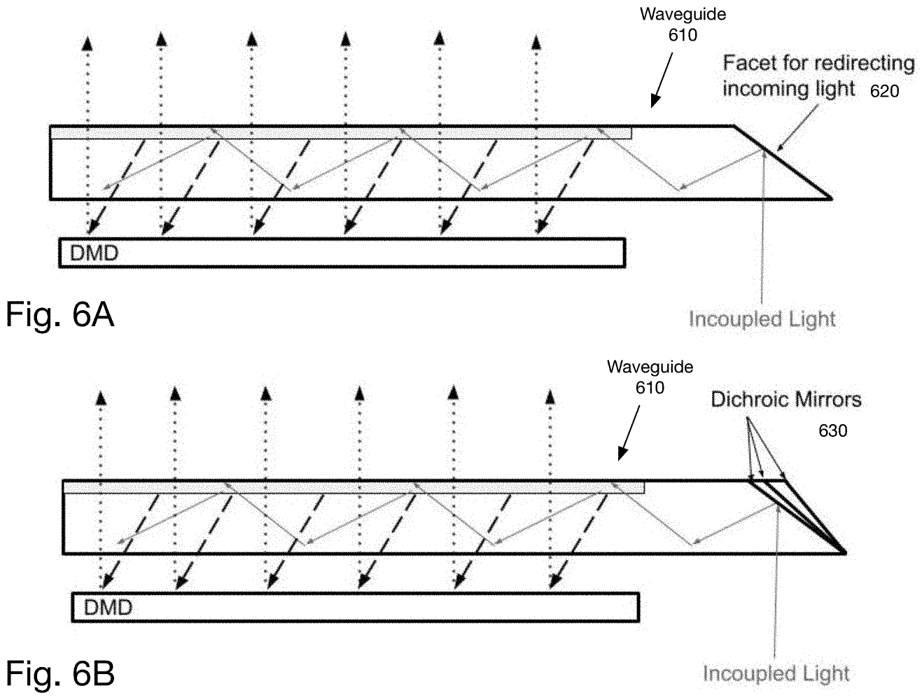

FIGS. 6A-6B are diagrams of one embodiment of a reflective in-coupler using dichroic mirrors. Instead of a waveguide 610 with a square corner at the in-coupling, the in-coupling is accomplished using a facet 620 or several facets with dichroic mirrors 630, to adjust the incident angle of the light. In one embodiment, there may be separate dichroic mirrors to adjust the angles of different colors of light. In one embodiment, the facets may include a curvature or power on that surface to help shape the illumination light before it is reflected through total internal reflection (TIR) inside the waveguide. In one embodiment, separate light sources are used for each color of light, aligned with each of the separate dichroic mirrors. In one embodiment, the light sources are LEDs.

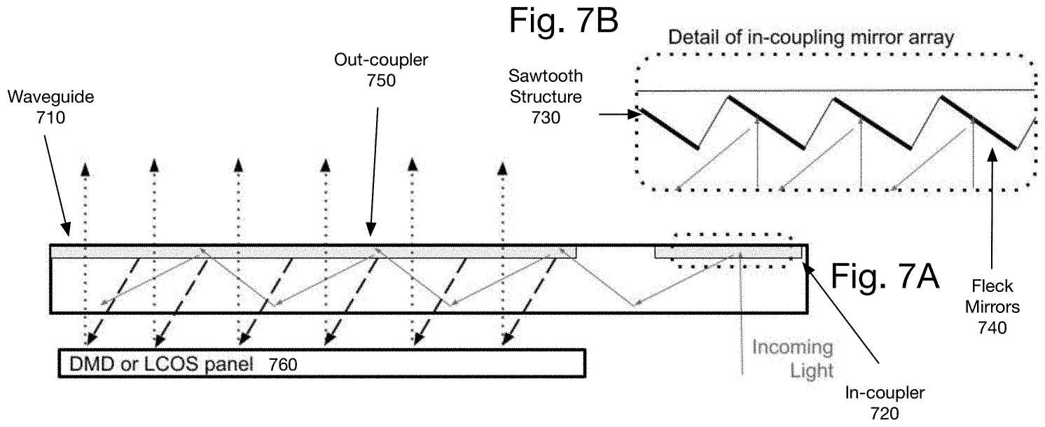

FIGS. 7A-7B are diagrams of one embodiment of a reflective in-coupler using fleck mirrors. The waveguide 710 includes an in-coupler 720 for incoming light, and an out-coupler 750 for light which is reflected from the DMD/LCOS/spatial light modulator 760.

In this embodiment, it is the in-coupler 720 that is replaced by a reflective element. The reflective element comprises a series of fleck mirrors 740 at an angle. In one embodiment, the fleck mirrors 740 are placed on one side of sawtooth elements. The fleck mirrors 740 reflect the light along the waveguide, to transmit the light toward the DMD 760. In one embodiment, for the in-coupler the fill factor may be higher than for an out-coupler, because the light need not pass back through the in-coupling area of the waveguide, after being modulated by the spatial light modulator. In one embodiment, the fill factor for the in-coupler 720 is 50-100%.

Typically, the light from the LED(s) is collimated using one or more collimating optics before relaying light onto a spatial light modulator 760, such as an LCoS or DLP panel. These collimating optics add weight, size, and cost to the overall system. Several other ways can be used to couple the light into the waveguide by shining the light into the edge of the waveguide and using other features inside the waveguide itself to shape the light before it hits any expansion or out-coupling features in the waveguide.

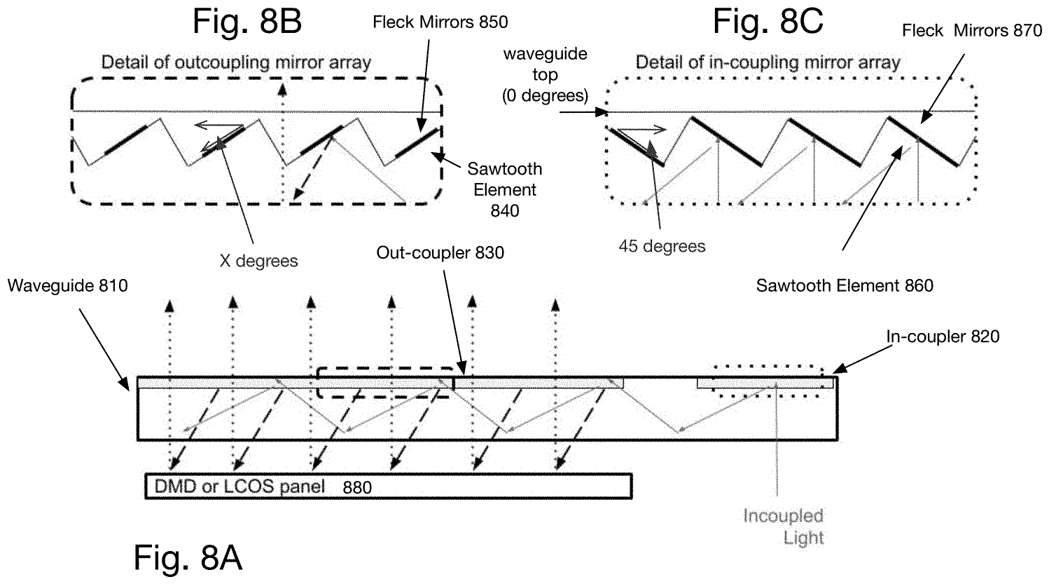

FIGS. 8A-8C are diagrams of one embodiment of a waveguide including a reflective in-coupler and a reflective out-coupler. As shown above, the illumination waveguide may include a reflective in-coupler, a reflective out-coupler, or as shown here a combination of reflective in-coupler and out-coupler.

As illustrated for waveguide 810, the in-coupler 820 and out-coupler 830 are on the same side of the waveguide, in one embodiment. The sawtooth elements 840 of the out-coupler have angles oriented in the opposite direction to the sawtooth elements 860 of the in-coupler 820. The in-coupler 820 with fleck mirrors 870 directs the light down the waveguide 810 through total internal reflection. In one embodiment, the top surface of the sawtooth elements 840 including the fleck mirrors 870 are angled at 45 degrees to the waveguide top. In contrast, the sawtooth elements 840 of the out-coupler 830 are directed at a shallower angle, with the mirrors oriented to receive the light that traveled down the waveguide, to redirect them to the spatial light modulator 880.

It is also visible that the relative coverage of the mirrors 850, 870 is different. The mirrors 870 in the in-coupler 820 cover the majority of the correctly angled portion of the sawtooth element 860, whereas the mirrors 850 in the out-coupler 830 only cover a portion of the sawtooth element 840. This allows the light modulated by the spatial modulator 880 to pass through the waveguide 810, as discussed above.

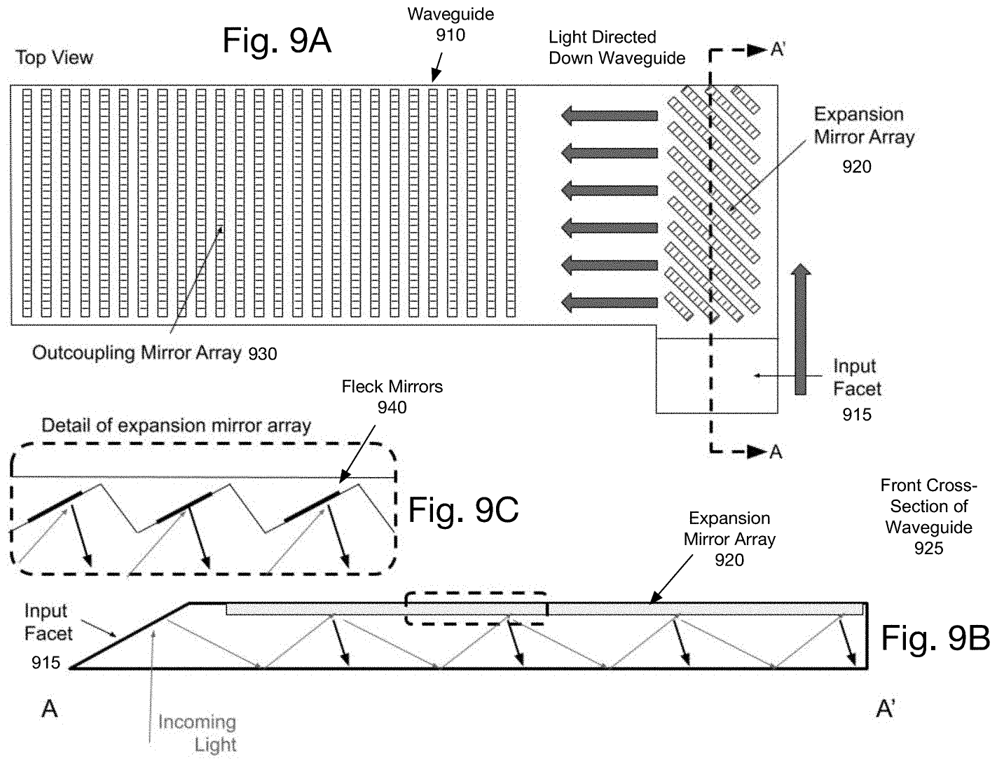

FIGS. 9A-9C are diagrams of one embodiment of a reflective element used as a waveguide expander. A waveguide expander expands the light input into the waveguide, before propagating it down the waveguide. In this illustration, in addition to the expansion mirror array 920, an out-coupling mirror-array is shown. One of skill in the art would understand that the system may include an expansion reflective element, an in-coupling reflective element, and/or an out-coupling reflective element in any combination.

The waveguide 910 in one embodiment includes an input facet 915, which is angled to direct the in-coupled light toward the expansion mirror array 920. In one embodiment, the input facet 915 is one or more dichroic mirrors, as described with respect to FIGS. 6A-6B. The input facet 915 may be any other type of in-coupling element, including a reflective in-coupler. The expansion mirror array 920 is positioned at an angle to the incoming light, and to the waveguide 910, to redirect the light from input facet 915 down the waveguide, as shown by the arrows. In one embodiment, the expansion mirror array's sawtooth elements are at an angle between 20 degrees and 70 degrees to the waveguide.

FIG. 9C illustrates the cross-section of the expansion mirror array and input facet 915, as cut across line A-A′ of FIG. 9A. FIG. 9C shows the enlargement of the expansion mirror array. The angled sawtooth elements with fleck mirrors 940 direct the light at an angle, into the waveguide 910. The out-coupling mirror array 930 directs the light from the waveguide toward the user, after it is reflected from the spatial light modulator (not shown).

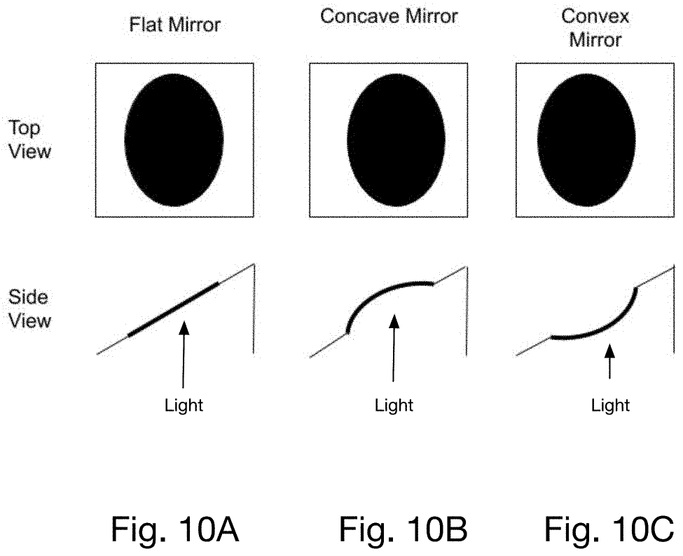

FIG. 10A-10C are diagrams illustrating various embodiments of altering the sloped surfaces of the sawtooth elements on which the fleck mirrors are positioned in a waveguide. In one embodiment, such a convex or concave shape is used to alter the angular range of the light reflected by the fleck mirrors in the waveguide. In one embodiment, it may also be used to apply an optical power. The sloped areas shown illustrate one sawtooth of the sawtooth element of the in-coupler, out-coupler, or expansion element of the waveguide. FIG. 10A illustrates the conventional design in which the sawtooth surface is flat. FIG. 10B illustrates a concave sawtooth on which a mirror is positioned, thereby forming a concave fleck mirror with respect to the incoming light, whereas FIG. 10C illustrates a convex sawtooth with a convex fleck mirror, with respect to the light. A concave or convex mirror may be used to shape the light. Although the illustrated images show the sawtooth shape with only the area on which the mirror is positioned being curved, one of skill in the art would understand that the entire sawtooth may be curved, to provide the concavity or convexity for the mirror. Additionally, the shape of the mirror is not restricted to the oval shape shown. Rather, this type of power may be applied to mirrors of any size or shape. Additionally, one of skill in the art would understand that a single sawtooth element may, in one embodiment, include a plurality of mirrors.

FIGS. 11A-11B are diagrams illustrating one embodiment of a waveguide having multiple in-coupled light packages. The waveguide 1110 has an in-coupler 1160, into which light from two separate light packages 1130, 1135 (together, light packages 1130) are directed. In one embodiment, the in-coupler 1160 is a facet, which directs the light from the two LED packages 1120 down the waveguide. In one embodiment, there is a single in-coupler 1160 through which the light from both LED packages 1120 is input to the waveguide 1110. In another embodiment, there may be more than one in-coupler 1160. For certain size combinations, two smaller LEDs will have a smaller volume and better uniformity than one large LED. For instance, two 0.3 mm circular LEDs can fit across the width of the waveguide inside 0.6 mm. This is 0.1 mm longer than a 0.5 mm circular LED, but it is only 0.3 mm in the orthogonal direction instead of 0.5 mm. The output profile of these two LEDs is spread more evenly across the width of the waveguide vs a single 0.5 mm LED, resulting in better intensity uniformity across the SLM 1180. In one embodiment, the system may also permit illumination of a part of the SLM 1180, enabling a partial image to be projected. Such a partial image may be particularly useful in an augmented reality (AR) system. However, it may also be used in a virtual reality (VR) or mixed reality (MR) system.

FIG. 12A-12D are diagrams illustrating one embodiment of using a micro-LED panel for selective lighting of a spatial light modulator. The waveguide 1210 includes an in-coupler 1220, and an out-coupler 1230. The light source, rather than a traditional LED, is a panel of micro-LEDs 1240. A panel of micro-LEDs may include one or more micro-LED strips. In one embodiment the micro-LED panel may include multiple colors. In one embodiment, the micro-LED panel may also be Quantum Dot illuminated micro-LEDs. In one embodiment, the micro-LEDs 1240 are between 1 μm and 50 μm per micro-LED, with a pitch between 2 μm and 100 μm. The micro-LED panel 1240 extends along the width of the waveguide 1210, in one embodiment. In one embodiment, the micro-LED panel includes integrated micro optics to shape the light output of each micro-LED.

The advantage of this configuration is that the micro-LED panel takes up less space than a traditional LED configuration. Furthermore, in one embodiment, the micro-LEDs in the micro-LED panel 1240 may be selectively activated, enabling selective illumination of the DMD 1250. This is particularly useful for augmented reality systems, where the virtual image covers only a relatively small portion of the visible areas. By using a targeted micro-LED panel, illuminating only the relevant segment of the DMD or other spatial light modulator, the system saves considerable power and thus battery life.

FIG. 12C illustrates one embodiment of a top view of the waveguide under full illumination, when the micro-LED panel 1240 illuminates across its entire length, illuminating the entire DMD (not shown) and thus showing an image over the entire display area. FIG. 12D in contrast illustrates one embodiment of a top view of the waveguide under partial illumination, where only a portion of the micro-LED panel 1240 is illuminated. This means only a portion of the DMD is illuminated. The resulting image would cover only a portion of the display. This may be useful for augmented reality (AR) displays, where the AR-overlay data is only shown on a part of the display area. By utilizing a portion of a micro-LED panel 1240, the system can save power not only in powering the LEDs but also in adjusting the DMD.

FIGS. 13A-13B illustrate embodiments of an in-coupling shape that may be used with a waveguide. FIGS. 13A-13B illustrate the ends of two different exemplary waveguides 1310, 1350 with different shaped in-couplers. The LED or other light source 1330, 1370 is attached onto the shaped end of the waveguide, which is the in-coupling portion 1320, 1360 of the waveguide 1310, 1350. In one embodiment, for the configurations shown in FIGS. 13A-13B the light source may be multiple LEDs, micro-LEDs, or micro-LED panel. In one embodiment, this type of edge illumination utilizes a one dimensional coherent beam combiner (CBC) between the LED 1330, 1370 and the waveguide 1320, 1360.

In one embodiment, shown in FIG. 13A, the shaped end of the waveguide 1310 is a spherical dome shape. In one embodiment, the in-coupler 1320 of the waveguide 1310 is hemispherical. In one embodiment, the in-coupler 1320 of the waveguide 1310 is defined by a spline. In one embodiment, the end of the waveguide 1310 has a flat area at the top where the LED or light source 1330 is attached. The light entering the waveguide at wider angles then bounces off the angled side of the shaped in-coupler, being directed down the waveguide, as shown.

In another embodiment, shown in FIG. 13B the waveguide 1350 shaped in-coupler has a trapezoidal cross section 1360. The light at larger angles from the LED 1370 interacts with the angled surface at the shaped end of the waveguide 1310, 1350 and is reflected 1340, 1380 down the waveguide at an angle better suited to interact with the out-coupling mirrors.

FIG. 14 illustrates one embodiment of a front portion of a waveguide illuminator including light shaping elements. The light shaping elements 1420, 1430 are shown on the top and bottom surface of a waveguide illuminator 1410. In one embodiment, the waveguide 1410 may include only one light shaping element on the top or the bottom of the waveguide. These shaping elements 1420, 1430 can be used to increase the efficiency of an edge coupled illumination LED, micro-LED, or micro-LED panel. In one embodiment, the light shaping elements 1420, 1430 are Fresnel lenses. In another embodiment, the light shaping elements 1420, 1430 are diffractive optical elements. In another embodiment, the light shaping elements 1420, 1430 are arrays of mirrors. In another embodiment, the light shaping elements 1420, 1430 are holographic optical elements.

FIG. 15 is a flowchart of one embodiment of manufacturing the reflective element using fleck mirrors. The process starts at block 1510. At block 1520, the lower layer is molded, with a sawtooth pattern. The reflective element may be for an in-coupler, an out-coupler, and/or an extender, as discussed above. The waveguide is molded out of glass or plastic or a similar material transparent to light.

At block 1530, in one embodiment a lithography process is used to apply fleck mirrors to a portion of the sawtooth pattern. The fleck mirrors are designed to reflect light toward the lower layer of the waveguide, below which a spatial light modulator (SLM) is positioned, at the correct angle for the SLM when the illumination waveguide is in use. As discussed above, the fill factor/coverage may range between 5% and 100%, depending on the use, and type of mirror material used. In one embodiment, the fleck mirror is metallic and at least partially reflective. As noted above, the fleck mirror may be polarization selective, color selective, dielectric material, holographic material, in various embodiments. Other methods of applying the fleck mirrors may be used.

At block 1540, in one embodiment, an absorption material is deposited on the top or back side of the mirrors facing away from the lower layer of the waveguide. In one embodiment the absorption material is metal, thin film black carbon, or polarizer material, porous chromium, carbon, or another visible light absorbing layer. In another embodiment, this step may be skipped. In one embodiment, the mirror material is reflective in one direction and light absorptive in the other direction.

At block 1550, a refraction index matched adhesive layer is applied.

At block 1560, a liquid polymer or other material is applied to create a flat top layer of the waveguide. The sawtooth and mirror array is thus fully enclosed within the waveguide. As shown in the figures, in one embodiment, the reflective element is near the top of the waveguide. However, the reflective element may be in a different position within the waveguide. The positioning of the reflective elements depends on the use of the reflective element, as in-coupler, out-coupler, and/or expander.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An illumination waveguide comprising:
a waveguide body having a top surface and a bottom surface;
a plurality of fleck mirrors within the waveguide, the fleck mirrors at an angle to the top surface of the waveguide, the fleck mirrors providing one or more of: an in-coupler, an out-coupler, and an extender to the waveguide;
wherein light from the waveguide is directed to a spatial light modulator by the fleck mirrors, and the modulated light is directed through the waveguide to a user.

2. The waveguide of claim 1, wherein the fleck mirrors comprise an out-coupler, and the reflective elements are configured to reflect light from the waveguide to the spatial light modulator, and to pass light from the spatial light modulator through the waveguide.

3. The waveguide of claim 1, wherein the fleck mirrors have a random distribution.

4. The waveguide of claim 1, further comprising:
a plurality of sawtooth elements within the waveguide, wherein the fleck mirrors are deposited on a surface of the sawtooth elements.

5. The waveguide of claim 4, wherein the waveguide comprises:
a first layer having the sawtooth elements;
a second layer with the fleck mirrors; and
a third layer to create a flat top layer for the waveguide.

6. The waveguide of claim 1, wherein the fleck mirrors have a fill factor between 5% and 80%.

7. The waveguide of claim 6, wherein a fill factor of the fleck mirrors varies across the waveguide.

8. The waveguide of claim 1, further comprising:
a non-reflective back surface of the fleck mirrors.

9. The waveguide of claim 1, further comprising:
the fleck mirrors being one of convex or concave.

10. The waveguide of claim 1, wherein the fleck mirrors are made of a holographic material that reflects a first set of wavelengths, and passes a second set of wavelengths.

11. The waveguide of claim 1, wherein the fleck mirrors comprise dichroic mirrors.

12. The waveguide of claim 1, wherein the in-coupler in-couples light from two light emitting diode packages, the two light emitting diode packages providing a smaller volume and better lighting uniformity.

13. The waveguide of claim 1, wherein the in-coupler in-couples light from a micro-LED (light emitting diode) panel, comprising a plurality of small LEDs, and wherein the micro-LED panel may light only a portion of the spatial light modulator.

14. The waveguide of claim 1, wherein:
the in-coupler is a shaped in-coupler, having an angled portion, such that a portion of the light is reflected from the angled portion into the waveguide.

15. The waveguide of claim 1, further comprising:
an edge illumination element, and a shaped end of the waveguide.

16. The waveguide of claim 15, wherein the shaped end has one of: a hemispherical shape, a trapezoidal shape, or a shape defined by a spline.

17. The waveguide of claim 15, further comprising:
a light shaping element in proximity to a light source on one or both of a top of the waveguide and a bottom of the waveguide.

18. The waveguide of claim 17, wherein the light shaping element comprises one or more of: Fresnel lenses, diffractive optical elements, arrays of mirrors, and holographic optical elements.

19. A head mounted display system comprising:
a light source;
an illumination waveguide including a plurality of reflective elements, the reflective elements at an angle to a top surface of the waveguide, the reflective elements providing one or more of: an in-coupler, an out-coupler, and an extender to the waveguide;
a spatial light modulator;
wherein the illumination waveguide directs light from the light source to the spatial light modulator and wherein modulated light from the spatial light modulator passes through the illumination waveguide toward a user's eye.

20. The head mounted display system of claim 19, wherein the light source comprises: light emitting diodes (LEDs), a plurality of LED packages providing a smaller volume and better lighting uniformity, or a micro-LED panel comprising a plurality of small LEDs.
